(19) United States
(12) Patent Application Publication
(10) Pub. No.: US 2014/0220221 A1
(43) Pub. Date: Aug. 7, 2014

(54) COMPOSITIONS AND METHODS FOR CONCENTRATED SYRUPS AND DROPS

(71) Applicants: David Del Pozo, Atlanta, GA (US); Marissa Charytan, Atlanta, GA (US)

(72) Inventors: David Del Pozo, Atlanta, GA (US); Marissa Charytan, Atlanta, GA (US)

(73) Assignee: The Coca-Cola Company, Atlanta, GA (US)

(21) Appl. No.: 14/170,232

(22) Filed: Jan. 31, 2014

Related U.S. Application Data
(60) Provisional application No. 61/759,954, filed on Feb. 1, 2013.

(51) Int. Cl. A23L 2/385; B67D 1/00

(52) U.S. Cl. CPC A23L 2/385; B67D 1/0004
USPC 426/590; 426/548; 426/74; 426/72; 222/129.1

(57) ABSTRACT

The principles of the present invention provide novel compositions and methods for making a low-chloride salt blend, high-concentrate beverage syrup. The method includes combining a high-concentrate beverage syrup and a salt blend low in chlorides to maintain organoleptic properties while minimizing corrosion of metallic components in beverage dispensers.

### CROSS-REFERENCE TO RELATED APPLICATIONS

This application claims the benefit of U.S. provisional application 61/759,954 filed Feb. 1, 2013, which is incorporated herein by reference in its entirety.

### BACKGROUND OF THE INVENTION

1. Field of the Invention

The principles of the present invention relate generally to the field of beverage formulation. In particular, composition and methods for reducing chlorides in high-concentrate beverage syrup, thus reducing corrosion in beverage dispensers and manufacturing surfaces in contact with this concentrate, are provided by the principles of the present invention.

2. Background of the Invention

In some types of beverage dispensers, beverage sources that include concentrates are mixed with a liquid to prepare the beverage. The dispenser dispenses a base beverage, such as a soft drink syrup, and an agent for diluting that syrup. Unfortunately, the high concentration of chloride salts found in such concentrates, which contribute to the optimal organoleptic, functional or nutritional characteristics of the reconstituted beverage, can result in chloride induced corrosion phenomena. Pitting corrosion of most metals (including stainless steels and high-alloyed materials) is the extremely localized partial attack by halides (chlorides in particular) through the formation and growth of pits in an autocatalytic process. The chlorides destroy the passive layer of metals via a very localized form of galvanic corrosion. This corrosion is evident from the rusting of steel components throughout the dispenser that come in contact with the beverage concentrate. However, chlorides cannot be entirely avoided as a component of beverage concentrates. Therefore, development of new beverage formulations with satisfactory nutritional characteristics and flavor profiles represents an ongoing challenge for the beverage industry.

### SUMMARY OF THE INVENTION

In one aspect, the principles of the present invention provide a composition. In one embodiment, the composition includes a high-concentrate beverage syrup. In yet another embodiment, the high-concentrate beverage syrup includes a salt blend. In certain embodiments, the salt blend includes at least two salts selected from the group consisting of chlorides, citrates, phosphates, gluconates, carbonates, sulfates, and lactates. In particular embodiments, the high-concentrate beverage syrup includes about 10,000 ppm chloride or less.

In certain embodiments, the composition includes an electrolyte solution of salts selected from the group consisting of sodium, potassium, magnesium, calcium, and zinc, or combinations thereof. In some embodiments, the composition includes sodium from about 100 mg/L, about 200 mg/L, about 300 mg/L, about 400 mg/L, about 500 mg/L, about 600 mg/L, about 700 mg/L, about 800 mg/L, about 900 mg/L, about 1,000 mg/L, about 5,000 mg/L, about 10,000 mg/L, about 25,000 mg/L, about 50,000 mg/L, about 75,000 mg/L, about 100,000 mg/L, about 125,000 mg/L, about 150,000 mg/L, or about 185,000 mg/L to about 300,000 mg/L, about 250,000 mg/L, about 200,000 mg/L, about 175,000 mg/L, about 150,000 mg/L, about 125,000 mg/L, about 100,000 mg/L, about 75,000 mg/L, about 50,000 mg/L, about 25,000 mg/L, about 10,000 mg/L, about 5,000 mg/L, and combinations thereof.

In other embodiments, the composition includes potassium from about 25 mg/L, about 50 mg/L, about 75 mg/L, about 100 mg/L, about 200 mg/L, about 300 mg/L, about 400 mg/L, about 500 mg/L, about 1,000 mg/L, about 5,000 mg/L, about 10,000 mg/L, about 20,000 mg/L, about 30,000 mg/L, about 40,000 mg/L, or about 50,000 mg/L to about 200,000 mg/L, about 150,000 mg/L, about 100,000 mg/L, about 75,000 mg/L, about 50,000 mg/L, about 25,000 mg/L, about 10,000 mg/L, about 7,500 mg/L, about 5,000 mg/L, about 2,500 mg/L, about 1,000 mg/L, about 500 mg/L, and combinations thereof.

In certain embodiments, the composition includes magnesium from about 5 mg/L, about 50 mg/L, about 100 mg/L, about 150 mg/L, about 200 mg/L, about 250 mg/L, about 300 mg/L, about 350 mg/L, about 400 mg/L, about 500 mg/L, about 750 mg/L, about 1,000 mg/L, about 1,250 mg/L, about 1,500 mg/L, about 1,750 mg/L, or about 2,000 mg/L, to about 200,000 mg/L, about 150,000 mg/L, about 100,000 mg/L, about 75,000 mg/L, about 50,000 mg/L, about 25,000 mg/L, about 10,000 mg/L, about 7,500 mg/L, about 5,000 mg/L, about 2,500 mg/L, about 1,000 mg/L, about 500 mg/L, and combinations thereof.

In some embodiments, the composition includes calcium from about 5 mg/L, about 50 mg/L, about 100 mg/L, about 200 mg/L, about 300 mg/L, about 400 mg/L, about 500 mg/L, about 600 mg/L, about 700 mg/L, about 800 mg/L, about 900 mg/L, about 1000 mg/L, about 2,000 mg/L, about 3,000 mg/L, about 4,000 mg/L, about 5,000 mg/L, or about 6,000 mg/L to about 200,000 mg/L, about 150,000 mg/L, about 100,000 mg/L, about 75,000 mg/L, about 50,000 mg/L, about 25,000 mg/L, about 10,000 mg/L, about 7,500 mg/L, about 5,000 mg/L, about 2,500 mg/L, about 1,000 mg/L, about 500 mg/L, and combinations thereof.

In yet other embodiments, the composition includes zinc from about 1 mg/L, about 2 mg/L, about 3 mg/L, about 4 mg/L, about 5 mg/L, about 10 mg/L, about 20 mg/L, about 30 mg/L, about 40 mg/L, about 50 mg/L, about 60 mg/L, about 70 mg/L, about 80 mg/L, about 90 mg/L, about 100 mg/L, about 500 mg/L, about 1,000 mg/L, about 2,000 mg/L, about 3,000 mg/L, about 4,000 mg/L, or about 5,000 mg/L to about 20,000 mg/L, about 15,000 mg/L, about 10,000 mg/L, about 7,500 mg/L, about 5,000 mg/L, about 2,500 mg/L, about 1,000 mg/L, about 750 mg/L, about 500 mg/L, about 250 mg/L, about 100 mg/L, about 50 mg/L, and combinations thereof.

In one embodiment, the composition includes sodium, potassium, magnesium, calcium, and zinc. In certain embodiments, the high-concentrate beverage syrup exhibits organoleptic, functional or nutritional characteristics similar to an equivalent high-concentrate beverage syrup having about 10,000 ppm chloride or greater. In some embodiments, the salt blend includes about 100 mg/L to about 185,000 mg/L sodium, about 25 mg/L to about 50,000 mg/L potassium, about 5 mg/L to about 2,000 mg/L magnesium, about 5 mg/L to about 6,000 mg/L calcium, and about 1 mg/L to about 5,000 mg/L zinc, or combinations thereof.

In yet another embodiment, the salt blend includes sodium, potassium, magnesium, calcium, and zinc, each from about 1 mg/L, about 100 mg/L, about 500 mg/L, about 1,000 mg/L, about 2,000 mg/L, about 5,000 mg/L, about 10,000 mg/L, about 25,000 mg/L, about 50,000 mg/L, about 100,000 mg/L, about 150,000 mg/L, or about 185,000 mg/L.

In certain embodiments, the composition includes natural, or artificial, non-nutritive or nutritive sweetener. In some embodiments, the non-nutritive sweetener includes at least one selected from the group consisting of Stevia rebaudiana extract, stevioside, cyclamate, neotame, erythritol, luo han guo, monk fruit, aspartame, saccharine, acesulfame potassium, and sucralose, or any combination or derivative thereof. In one embodiment the non-nutritive sweetener is rebaudioside A (Reb A). In yet another embodiment, the composition includes a nutritive sweetener. In some embodiments, the nutritive sweetener includes at least one selected from the group consisting of sucrose, fructose, glucose, polydextrose, and trehalose, from natural or purified sources or any combination or derivative thereof. In certain embodiments, the composition includes an additive selected from the group consisting of salts, food-grade acids, caffeine, emulsifiers, stabilizers, antioxidants, coloring agents, preservatives, energy-boosting agents, tea, botanicals, coffee, minerals and vitamins.

In another aspect, the principles of the present invention provide a method of producing a low-chloride, high-concentrate beverage syrup. In one embodiment, the method combines a high-concentrate beverage syrup and a salt blend. In some embodiments, the method includes adding the salt blend including at least two salts selected from the group consisting of chlorides, citrates, phosphates, gluconates, carbonates, sulfates, and lactates. In particular embodiments, the method includes adding high-concentrate beverage syrup including about 10,000 ppm chloride or less.

In other embodiments, the method includes adding high-concentrate beverage syrup including sodium from about 100 mg/L, about 200 mg/L, about 300 mg/L, about 400 mg/L, about 500 mg/L, about 600 mg/L, about 700 mg/L, about 800 mg/L, about 900 mg/L, about 1,000 mg/L, about 5,000 mg/L, about 10,000 mg/L, about 25,000 mg/L, about 50,000 mg/L, about 75,000 mg/L, about 100,000 mg/L, about 125,000 mg/L, about 150,000 mg/L, or about 185,000 mg/L.

In one embodiment, the method includes adding high-concentrate beverage syrup including potassium from about 25 mg/L, about 50 mg/L, about 75 mg/L, about 100 mg/L, about 200 mg/L, about 300 mg/L, about 400 mg/L, about 500 mg/L, about 1,000 mg/L, about 5,000 mg/L, about 10,000 mg/L, about 20,000 mg/L, about 30,000 mg/L, about 40,000 mg/L, or about 50,000 mg/L. In yet another embodiment, the method includes adding high-concentrate beverage syrup including magnesium from about 5 mg/L, about 50 mg/L, about 100 mg/L, about 150 mg/L, about 200 mg/L, about 250 mg/L, about 300 mg/L, about 350 mg/L, about 400 mg/L, about 500 mg/L, about 750 mg/L, about 1,000 mg/L, about 1,250 mg/L, about 1,500 mg/L, about 1,750 mg/L, or about 2,000 mg/L. In some embodiments, the method includes adding high concentrate beverage syrup including calcium from about 5 mg/L, about 50 mg/L, about 100 mg/L, about 200 mg/L, about 300 mg/L, about 400 mg/L, about 500 mg/L, about 600 mg/L, about 700 mg/L, about 800 mg/L, about 900 mg/L, about 1000 mg/L, about 2,000 mg/L, about 3,000 mg/L, about 4,000 mg/L, about 5,000 mg/L, or about 6,000 mg/L. In yet other embodiments, the method includes adding high-concentrate beverage syrup including zinc from about 1 mg/L, about 2 mg/L, about 3 mg/L, about 4 mg/L, about 5 mg/L, about 10 mg/L, about 20 mg/L, about 30 mg/L, about 40 mg/L, about 50 mg/L, about 60 mg/L, about 70 mg/L, about 80 mg/L, about 90 mg/L, about 100 mg/L, about 500 mg/L, about 1,000 mg/L, about 2,000 mg/L, about 3,000 mg/L, about 4,000 mg/L, or about 5,000 mg/L.

In certain embodiments, the method includes adding high-concentrate beverage syrup exhibiting organoleptic, functional or nutritional characteristics similar to an equivalent high-concentrate beverage syrup having about 10,000 ppm chloride or greater.

In yet another embodiment, the method includes adding the salt blend including sodium, potassium, magnesium, calcium, and zinc, each from about 1 mg/L, about 100 mg/L, about 500 mg/L, about 1,000 mg/L, about 2,000 mg/L, about 5,000 mg/L, about 10,000 mg/L, about 25,000 mg/L, about 50,000 mg/L, about 100,000 mg/L, about 150,000 mg/L, or about 185,000 mg/L.

In certain embodiments, the method includes producing a composition including natural, or artificial, non-nutritive or nutritive sweetener. In some embodiments, the method includes producing a composition including a non-nutritive sweetener including at least one selected from the group consisting of Stevia rebaudiana extract, stevioside, cyclamate, neotame, erythritol, luo han guo, monk fruit, acesulfame potassium, aspartame, saccharine, and sucralose, or any combination or derivative thereof. In one embodiment the method includes producing a composition including the non-nutritive sweetener rebaudioside A (Reb A). In yet another embodiment, the method includes producing a composition including a nutritive sweetener. In some embodiments, the method includes producing a composition including a nutritive sweetener including at least one selected from the group consisting of sucrose, fructose, glucose, polydextrose, and trehalose, from natural or purified sources. In certain embodiments, the method includes producing a composition including an additive selected from the group consisting of salts, food-grade acids, caffeine, emulsifiers, stabilizers, antioxidants, coloring agents, preservatives, energy-boosting agents, tea, botanicals, coffee, minerals and vitamins.

In yet another aspect, the principles of the present invention provide a beverage dispenser. In one embodiment, the beverage dispenser includes a low-chloride, high-concentrate beverage syrup.

In one aspect, the principles of the present invention provide a method of reducing corrosion in an artifact used to manufacture, dispense or vend a beverage concentrate. In some embodiments, the method includes dispensing a low-chloride, high-concentrate beverage syrup from the artifact, whereby the artifact experiences less corrosion than an equivalent artifact including a high-chloride, high-concentrate beverage syrup.

In an additional aspect, the principles of the present invention provide a method of producing an electrolyte-enriched beverage. In some embodiments, the method includes mixing a composition, including a high-concentrate beverage syrup including a salt blend including at least two salts selected from the group consisting of chlorides, citrates, phosphates, gluconates, carbonates, sulfates, and lactates, wherein the syrup includes about 10,000 ppm chloride or less, with a volume of mixer to form a mixed beverage, whereby the mixed beverage includes an electrolyte concentration of about 100 mg/L to about 185,000 mg/L sodium, about 25 mg/L to about 50,000 mg/L potassium, about 5 mg/L to about 2,000 mg/L magnesium, about 5 mg/L to about 6,000 mg/L calcium, and about 1 mg/L to about 5,000 mg/L zinc, or combinations thereof.

In another aspect, the principles of the present invention provide an enhanced-hydration beverage. In one embodiment, the enhanced-hydration beverage includes a salt blend. In yet another embodiment, the salt blend includes at least two salts selected from the group consisting of chlorides, citrates, phosphates, gluconates, and lactates, wherein the beverage comprises about 1,000 ppm chloride or less.

These and other features, aspects, and advantages of the principles of the present invention will become better understood with reference to the following description and claims.

### BRIEF DESCRIPTION OF THE FIGURES

FIG. 1. Illustration of corrosion in manufacturing surfaces (A and B) and dispensing equipment (C and D) in direct contact with high-chloride fluids (>10,000 mg/L chlorides).

### DETAILED DESCRIPTION OF THE INVENTION

The principles of the present invention are based at least in part on the surprising discovery that a high-concentrate beverage syrup, comprising a salt blend low in chlorides, can maintain optimal organoleptic characteristics in the reconstituted beverage while significantly reducing corrosion of manufacturing and dispensing systems. As a result, manufacturing and dispensing equipment require less maintenance and the finished beverage product exhibits little flavor changes and optimal hydrating benefits. Accordingly, the principles of the present invention provide a high-concentrate beverage syrup with a novel salt blend with about 10,000 ppm chloride or less.

A common problem experienced by the various manufacturing and dispensing systems of solutions containing chloride salts is that chloride promotes corrosive attack on metal surfaces. The corrosiveness of high-chloride beverages is particularly troublesome in beverage dispensers where high-chloride concentration can cause rapid corrosion and deterioration of pump internal components such as metal springs, plungers, and piping. Since ionic salts are often composed of chloride ions and the taste of salt is one of the basic human tastes, its presence is generally required at a minimum concentration to ensure an acceptable flavor profile for any beverage. Any corrosive attack on the internal components of beverage dispensers, and the subsequent deterioration of such surfaces, is often difficult to assess and expensive to prohibit using high-grade stainless steel. Additionally, chloride corrosion of steel presents a significant health hazard to the end beverage consumer. The problem of accelerated corrosion by high-chloride containing beverages is a problem which has not been adequately addressed by the prior art.

In order to address this long standing issue and create a low-chloride, high-concentrate beverage syrup, experiments were conducted to attempt to change the minerals within a syrup to a non-chloride form while still delivering the same level of electrolytes without compromising taste and product acceptability. The form of the minerals plays a significant role in how the syrup functions in a manufacturing system. Since a high-concentrate beverage syrup has a ready-to-drink action standard, certain functional levels and taste expectations are to remain consistent, thus making the creation of a low-chloride, high-concentrate beverage syrup difficult. As such, one of the structural and functional differences of the principles of the present invention is the unexpected parity in taste and functionality, once diluted, to a standard ready-to-drink counterpart beverage achieved using a blend of chloride and non-chloride salts, while simultaneously providing a solution to the technical challenges faced with having a high-chloride concentrate system. As a result of the extensive testing of various mineral formulations, the principles of the present invention provide a syrup that can be manufactured without the risk of causing extensive damage to the metal components of dispensers and a manufacturing system and still maintain similar organoleptic properties with an equivalent high-concentrate beverage syrup high in chlorides.

Accordingly, the compositions and methods used herein also include methods of reducing the concentration of potentially hazardous chemicals from corrosion in a beverage dispenser that is introduced into consumer beverages. Without being bound by theory, reducing the concentration of chlorides in the beverage concentrate reduces the potentially hazardous interaction of chemicals released by the reaction of chlorides with surface-active chemicals present in manufacturing and/or packaging materials.

As used herein, “high-concentrate beverage syrup” is generally a solution or a dispersion containing ingredients to be reconstituted in a liquid mixer at a dilution from 2, 3, 4, 5, 6, 7, 8, 9, or 10 fold dilution to 50, 100, 200, 300, 400, 500, 1000 fold dilution, including all combinations thereof. In an embodiment the dilution is from 3-200-fold dilution. A typical example of such a high-concentrate beverage syrup can be soft drink syrup. In alternative embodiments, principles of the present invention can be used to provide low-chloride salt blends of carbonated and non-carbonated soft drinks, fountain beverages, frozen ready-to-drink beverages, coffee beverages, tea beverages, dairy beverages, powdered soft drinks, as well as liquid concentrates, flavored waters, enhanced waters, fruit juice and fruit juice-flavored drinks, sports drinks, and alcoholic products. In an embodiment, the moisture of the concentrate can be further reduced by methods known in the art to produce solid, powder and/or gel forms of the concentrated beverage. As appreciated by one of skill in the art, any of these beverages can be the starting material to be combined according to the methods herein, or are beverages to which low-chloride salt blends can be added.

As used herein, “salt blend” is generally a combination of inorganic, or organic, ionic compounds that are soluble in water.

As appreciated by one of skill in the art, water is a basic ingredient in the beverages disclosed here, typically being the primary liquid portion in which the high-concentrate beverage syrup is dissolved, emulsified, suspended or dispersed. Those of ordinary skill in the art will understand that, for convenience, some ingredients are described herein, in certain cases, by reference to the original form of the ingredient in which it is added to the beverage product formulation. Such original form may differ from the form in which the ingredient is found in the finished beverage product. For example, orange juice is generally made by extraction from the fresh fruit, by desiccation and subsequent reconstitution of dried juice, or by concentration of the juice and the subsequent addition of water to the concentrate. The beverage to be combined with a salt blend, for instance, can be fresh, can be one containing pulp, or can be one from which pulp has been removed by centrifugation or filtration.

Once made, the reconstituted high-concentrate beverage syrup can find use as a beverage of its own or can be mixed with one or more other beverages. Carbon dioxide can be used to provide effervescence to certain embodiments of the beverages disclosed herein. Any of the techniques and carbonating equipment known in the art for carbonating beverages can be employed. Cola beverages, which typically exhibit a dark brown color derived from caramel coloring resulting from heat-treated carbohydrates, can also benefit from the low-chloride salt blend composition in accordance with the principles of the present invention.

As used herein, “electrolyte solution” refers to a drink containing sodium, potassium, magnesium, calcium, or zinc salts to replenish the body's electrolyte and ion levels which can become diminished by dehydration caused by exercise. In some embodiments, the high-concentrate beverage syrup includes about 10,000 ppm chloride or less. In certain embodiments, the composition includes an electrolyte solution of salts selected from the group consisting of sodium, potassium, magnesium, calcium, and zinc, or combinations thereof.

In other embodiments, the composition includes sodium from about 100 mg/L, about 200 mg/L, about 300 mg/L, about 400 mg/L, about 500 mg/L, about 600 mg/L, about 700 mg/L, about 800 mg/L, about 900 mg/L, about 1,000 mg/L, about 5,000 mg/L, about 10,000 mg/L, about 25,000 mg/L, about 50,000 mg/L, about 75,000 mg/L, about 100,000 mg/L, about 125,000 mg/L, about 150,000 mg/L, or about 185,000 mg/L. In particular embodiments, the composition includes potassium from about 25 mg/L, about 50 mg/L, about 75 mg/L, about 100 mg/L, about 200 mg/L, about 300 mg/L, about 400 mg/L, about 500 mg/L, about 1,000 mg/L, about 5,000 mg/L, about 10,000 mg/L, about 20,000 mg/L, about 30,000 mg/L, about 40,000 mg/L, or about 50,000 mg/L. In certain embodiments, the composition includes magnesium from about 5 mg/L, about 50 mg/L, about 100 mg/L, about 150 mg/L, about 200 mg/L, about 250 mg/L, about 300 mg/L, about 350 mg/L, about 400 mg/L, about 500 mg/L, about 750 mg/L, about 1,000 mg/L, about 1,250 mg/L, about 1,500 mg/L, about 1,750 mg/L, or about 2,000 mg/L. In some embodiments, the composition includes calcium from about 5 mg/L, about 50 mg/L, about 100 mg/L, about 200 mg/L, about 300 mg/L, about 400 mg/L, about 500 mg/L, about 600 mg/L, about 700 mg/L, about 800 mg/L, about 900 mg/L, about 1000 mg/L, about 2,000 mg/L, about 3,000 mg/L, about 4,000 mg/L, about 5,000 mg/L, or about 6,000 mg/L. In yet other embodiments, the composition includes zinc from about 1 mg/L, about 2 mg/L, about 3 mg/L, about 4 mg/L, about 5 mg/L, about 10 mg/L, about 20 mg/L, about 30 mg/L, about 40 mg/L about 50 mg/L, about 60 mg/L, about 70 mg/L, about 80 mg/L, about 90 mg/L, about 100 mg/L, about 500 mg/L, about 1,000 mg/L, about 2,000 mg/L, about 3,000 mg/L, about 4,000 mg/L, or about 5,000 mg/L.

The salts can be present at similar or different amounts relative to each other. At least the organoleptic, functional or nutritional properties of the diluted low-chloride, high-concentrate beverage syrup are similar when compared to an equivalent diluted high-chloride, high-concentrate beverage syrup.

As used herein, “equivalent high-concentrate beverage syrup” is a version of a beverage syrup that does not include the low-chloride salt blend composition in accordance with the principles of the present invention.

As used herein, a “non-nutritive sweetener” is one that does not provide significant caloric content in typical usage amounts, i.e., is one which imparts less than 5 calories per 8 ounce serving of beverage to achieve the sweetness equivalent of 10 Brix of sugar. In various embodiments, the high-concentrate beverage syrup composition further includes a non-nutritive sweetener selected from Stevia rebaudiana extract, stevioside, cyclamate, neotame, erythritol, luo han guo, monk fruit, acesulfame potassium, aspartame, saccharine, and sucralose, or any combination or derivative thereof. In one embodiment the non-nutritive sweetener is rebaudioside A (Reb A).

As used herein, a “nutritive sweetener” is one that can provide significant caloric content in typical usage amounts, i.e., is one which imparts greater than 5 calories per 8 ounce serving of beverage to achieve the sweetness equivalent of 10 Brix of sugar. In various embodiments, the high-concentrate beverage syrup composition further includes a nutritive sweetener selected from the group consisting of sucrose, fructose, glucose, polydextrose, and trehalose, from natural or purified sources.

As used herein, degrees Brix (°Bx) is the sugar content of an aqueous solution. One degree Brix is 1 gram of sucrose in 100 grams of solution and represents the strength of the solution as percentage by weight (% w/w).

It should be understood that beverages and other beverage products can have any of numerous different specific formulations or constitutions. In general, a beverage typically comprises at least water, acidulant, and flavoring. The beverage products in accordance with the principles of the present invention include beverages, i.e., ready to drink formulations, beverage concentrates, and the like. Juices suitable for use in at least embodiments include, for example, fruit, vegetable, and berry juices. In beverages employing juice, juice may be used, for example, at a level from about 0.2%, about 0.5%, about 1%, about 2%, about 3%, about 5%, about 10%, about 15%, about 20%, about 25%, about 30%, about 35%, about 40%, about 50%, about 60%, about 70%, about 80%, about 90% to about 99% juice by weight of the beverage.

Accordingly, the principles of the present invention provide a low-chloride, high-concentrate beverage syrup comprising a salt blend comprising at least two salts selected from the group consisting of chlorides, citrates, phosphates, gluconates, carbonates, sulfates, and lactates, wherein the syrup comprises about 10,000 ppm chloride or less. Beverages, of which the taste profiles may be modified by the addition of sweeteners, can be provided. Various beverages, such as sport drinks, contain a significant amount of chloride ions and thus increase the corrosive wear on the manufacturing and dispensing systems that contain them.

To prepare a high-concentrate beverage syrup composition of the present invention standard beverage formulation methods can be used. Examples of beverage formulation can be found in U.S. Pat. Nos. 4,061,797; 4,737,375; 4,830,862; 5,597,595; 5,976,602; 5,993,882; 6,294,214; 6,350,484; 6,455,511; 7,157,109; 7,651,717; 7,897,192; 7,993,690; and 8,029,846, each of which is expressly incorporated herein by reference. The principles of the present invention provide a method of producing a low chloride, high-concentrate beverage syrup comprising combining a high-concentrate beverage syrup and a salt blend comprising at least two salts selected from the group consisting of chlorides, citrates, phosphates, gluconates, and lactates, wherein the syrup comprises about 10,000 ppm chloride or less.

At least one ion other than chloride can be used. Beverages using different salt compounds are known in the art. However, to address the problem of using chloride-containing salts, the principles of the present invention make use of non-chloride containing salts to reduce the corrosive properties of the beverage while maintaining palatable characteristics.

There are many known salt metal-ion compatible compounds that find use in accordance with the principles of the present invention, such as, but not limited to, citrates, phosphates, gluconates, and lactates. There are many known salt metal-ions compatible with the non-chloride anion compounds that find use in accordance with the principles of the present invention, such as, but not limited to, sodium, potassium, magnesium, calcium, and zinc.

Non-nutritive sweeteners, also called artificial sweeteners, or high-intensity sweeteners, are agents that exhibit a sweetness many times that of sucrose. Examples of high-intensity sweeteners include saccharin, cyclamate, aspartame, monatin, alitame, acesulfame potassium, sucralose, thaumatin, stevioside, glycyrrhizin, sucralose, and neotame. Therefore, beverages such as fruit juice, sports drinks, and soft drinks, are sweetened with non-nutritive sweeteners that may not occur naturally in the source ingredients for the beverage and thus are generally regarded as undesirable by many consumers. By contrast, nutritive sweeteners generally refer to naturally occurring substances. Examples of nutritive sweeteners include glucose, fructose, maltose, galactose, maltodextrin, trehalose, fructo-oligosaccharides, and trioses. Due to the prevalence and popularity of non-nutritive sweeteners in beverages, several processes have been described for modifying the taste profile of beverages that contain these non-nutritive sweeteners.

As used herein, “additive” means food additive, or a substance added to food to preserve flavor or enhance its taste and appearance. In some embodiments, the composition further includes an additive selected from salts, food-grade acids, caffeine, emulsifiers, stabilizers, antioxidants, coloring agents, preservatives, energy-boosting agents, tea, botanicals, coffee, minerals and vitamins. Further, it will generally be an option to add other ingredients to the formulation of a particular beverage embodiment, including flavorings, electrolytes, tastents, masking agents, flavor enhancers, carbonation, or caffeine.

Definitions and methods described herein are provided to better define the present disclosure and to guide those of ordinary skill in the art in the practice of the present disclosure. Unless otherwise noted, terms are to be understood according to conventional usage by those of ordinary skill in the relevant art.

In some embodiments, numbers expressing quantities of ingredients, properties such as molecular weight, reaction conditions, and so forth, used to describe and claim certain embodiments of the present disclosure are to be understood as being modified in some instances by the term “about.” In some embodiments, the term “about” is used to indicate that a value includes the standard deviation of the mean for the device or method being employed to determine the value. In some embodiments, the numerical parameters set forth in the written description and attached claims are approximations that can vary depending upon the desired properties sought to be obtained by a particular embodiment. In some embodiments, the numerical parameters should be construed in light of the number of reported significant digits and by applying ordinary rounding techniques. Notwithstanding that the numerical ranges and parameters setting forth the broad scope of some embodiments of the present disclosure are approximations, the numerical values set forth in the specific examples are reported as precisely as practicable. The numerical values presented in some embodiments of the present disclosure may contain certain errors necessarily resulting from the standard deviation found in their respective testing measurements. The recitation of ranges of values herein is merely intended to serve as a shorthand method of referring individually to each separate value falling within the range. Unless otherwise indicated herein, each individual value is incorporated into the specification as if it were individually recited herein.

In some embodiments, the terms “a” and “an” and “the” and similar references used in the context of describing a particular embodiment (especially in the context of certain of the following claims) can be construed to cover both the singular and the plural, unless specifically noted otherwise. In some embodiments, the term “or” as used herein, including the claims, is used to mean “and/or” unless explicitly indicated to refer to alternatives only or the alternatives are mutually exclusive.

The terms “comprise,” “have” and “include” are open-ended linking verbs. Any forms or tenses of one or more of these verbs, such as “comprises,” “comprising,” “has,” “having,” “includes” and “including,” are also open-ended. For example, any method that “comprises,” “has” or “includes” one or more steps is not limited to possessing only those one or more steps and can also cover other unlisted steps. Similarly, any composition or device that “comprises,” “has” or “includes” one or more features is not limited to possessing only those one or more features and can cover other unlisted features.

All methods described herein can be performed in any suitable order unless otherwise indicated herein or otherwise clearly contradicted by context. The use of any and all examples, or exemplary language (e.g. “such as”) provided with respect to certain embodiments herein is intended merely to better illuminate the present disclosure and does not pose a limitation on the scope of the present disclosure otherwise claimed. No language in the specification should be construed as indicating any non-claimed element essential to the practice of the present disclosure.

Groupings of alternative elements or embodiments of the present disclosure disclosed herein are not to be construed as limitations. Each group member can be referred to and claimed individually or in any combination with other members of the group or other elements found herein. One or more members of a group can be included in, or deleted from, a group for reasons of convenience or patentability.

Having described the present disclosure in detail, it will be apparent that modifications, variations, and equivalent embodiments are possible without departing the scope of the present disclosure defined in the appended claims. Furthermore, it should be appreciated that all examples in the present disclosure are provided as non-limiting examples.

### EXAMPLES

The following non-limiting examples are provided to further illustrate the present disclosure. It should be appreciated by those of skill in the art that the techniques disclosed in the examples that follow represent approaches the inventors have found function well in the practice of the present disclosure, and thus can be considered to constitute examples of modes for its practice. However, those of skill in the art should, in light of the present disclosure, appreciate that many changes can be made in the specific embodiments that are disclosed and still obtain a like or similar result without departing from the spirit and scope of the present disclosure.

### Example 1

### Corrosion Evaluation of Manufacturing Components

The below example exemplifies the corrosion evaluation of manufacturing components during the Production & Dispensing of Highly-Concentrated beverages and syrups.

Pitting corrosion of most metals (including stainless steels and high-alloyed materials) is the extremely localized partial attack by halides (chlorides in particular) through the formation and growth of pits in an autocatalytic process. The chlorides destroy the passive layer of metals via a very localized form of galvanic corrosion. This corrosion is well documented and is evident from the rusting of steel components of artifacts that come in contact with beverages and concentrated beverage syrups during the manufacturing, dispensing or vending of these fluids.

To evaluate corrosion behavior of manufacturing components and drink dispensers in contact with multiple fluids different fluids containing beverage ingredients were tested. Components from a drink dispenser's pump included three springs of the same material and one plunger. The springs were 302 stainless steel, and the plunger was 400 series stainless steel. Failure of these components have been reported in the field. Two spring samples from these failures were submitted for visual examination.

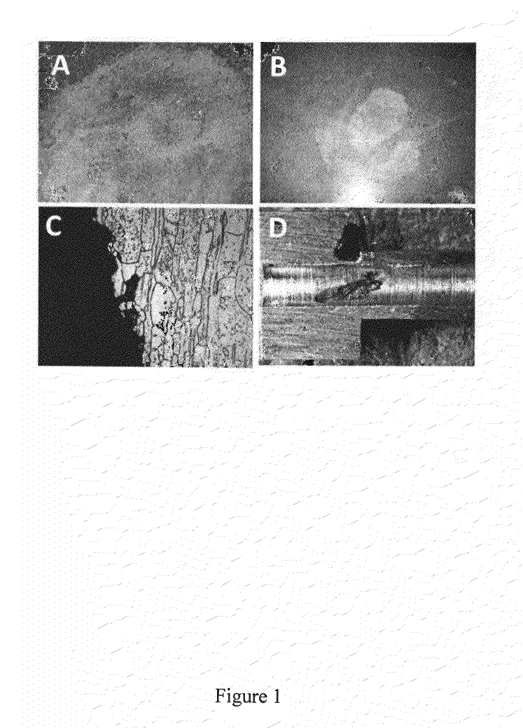

Visual inspection, physical performance, and rapid-corrosivity testing were used to determine the corrosion behavior of direct-contact surfaces during manufacturing of these fluids. The samples were evaluated using immersion in fluids for the duration of 14 days at 65° C. using ASTM G 4-01(08), Standard Guide for Conducting Corrosion Tests in Field Applications, as a guide. Fluids included samples of low chloride (≦1,000 ppm) or high chloride (>1,000 ppm) fluids. Pump components tested in fluids with chloride levels >10,000 ppm exhibited extensive corrosion leading to decreased production efficiency and in most cases failure (FIG. 1).

### Example 2

### Sensory Evaluation

Sensory evaluation and consumer acceptance of a beverage with Mixed Berry flavor reconstituted using water and either low chloride (≦1,000 ppm) or high chloride (>1,000 ppm) fluids (Benchmarks).

Central Location Test (CLT) with pre-recruited respondents was utilized. Each respondent was served 4 oz of chilled beverage (5° C.+/−1° C.) in a cup and asked to drink at least half before starting the questionnaire and finish sample before finishing questionnaire. Each respondent was requested to eat ½-1 unsalted cracker and take a drink of water and wait 2 minutes prior to tasting each beverage. A total of 4 beverages were tasted. Details of respondent and questionnaire methodology are as follows:

### Respondents

3 cells with 4 products in each cell
N=300 Sequential Monadic per cell (each respondent to taste all 4 variants in their cell)
3 markets: Boston, Los Angeles, and Atlanta
Non-rejecter of appropriate cell flavor
Screened for security and past 3 month participation
Must be able to consume products made with artificial and natural high potency sweeteners
No pregnant or lactating women

### Questionnaire Design

Overall Liking (9-point Hedonic scale)
Color Liking (9-point Hedonic scale)
Aroma Liking (9-point Hedonic scale)
Flavor Intensity (9-point intensity scale)
Sweetness Intensity (9-point Intensity scale)
Sourness Intensity (9-point Intensity scale)
Balance of Sweetness to Sourness (9-point Intensity scale)
Saltiness Expectations (5 point scale)
Aftertaste (Yes/No); [If yes . . . ] Aftertaste (Pleasant/Unpleasant); [If unpleasant . . . ]
Aftertaste (Open Ended Description)
Drinkability (5 point scale)
Purchase Intent (5 point scale)
Meet expectations (5 point scale)

Results from the consumer test concluded that all prototypes made from low chloride syrups (labeled as Sample Drops) scored greater than 6.0 in Overall Liking. All prototypes were significantly more liked than a prototype containing high-chloride levels (Control benchmark). Liking scores for Mixed Berry SAMPLE Drops prototypes ranged from 6.7-6.8 and were significantly higher than that of Control benchmark products (OL=5.5). Please see below for detailed results

### Total Respondents—N=303

Among total sample, Mixed Berry prototypes consistently outperformed benchmarks across all attributes.
The % unpleasant aftertaste ratings (12-15%) were significantly lower for prototypes vs. benchmarks (33-37%) among total sample.

| CELL 1 - Mixed | | | | |
|---|---|---|---|---|
| Berry Total | SAMPLE | SAMPLE | | |
| Respondents | Drops | Drops | Benchmark | Benchmark |
| N = 303 | Var #1 | Var #2 | #1 | #2 |
| Overall Liking | | | | |
| (9 pt. scale; | | | | |
| 1 = Dislike | | | | |
| Extremely, | | | | |
| 9 = Like Extremely) | | | | |
| Top 2 Box % | 45% A | 42% A | 28% B | 25% B |
| Mean | 6.7 A | 6.8 A | 5.7 B | 5.5 C |

Means with different letters indicate a significance difference at 90% one-tailed.

### Action Standard Metric—Overall Liking:

| | SAMPLE | SAMPLE | | |
|---|---|---|---|---|
| | Drops | Drops | Benchmark | Benchmark |
| | Var #1 | Var #2 | #1 | #2 |
| Overall Liking | | | | |
| (9 pt. scale; | | | | |
| 1 = Dislike | | | | |
| Extremely, | | | | |
| 9 = Like Extremely) | | | | |
| Top 2 Box % | 45% A | 42% A | 28% B | 25% B |
| Mean | 6.7 A | 6.8 A | 5.7 B | 5.5 C |

Means with different letters indicate a significance difference at 80% one-tailed.

| | SAMPLE | SAMPLE | | |
|---|---|---|---|---|
| | Drops | Drops | Benchmark | Benchmark |
| | Var #1 | Var #2 | #1 | #2 |
| Overall Liking | | | | |
| (9 pt. scale; | | | | |
| 1 = Dislike | | | | |
| Extremely, | | | | |
| 9 = Like Extremely) | | | | |
| Top 2 Box % | 45% A | 42% A | 28% B | 25% B |
| Mean | 6.7 A | 6.8 A | 5.7 B | 5.5 C |

Means with different letters indicate a significance difference at 90% one-tailed.

### Full Evaluation

| | SAMPLE | SAMPLE | | |
|---|---|---|---|---|
| | Drops | Drops | | Benchmark |
| | Var #1 | Var #2 | Benchmark #1 | #2 |
| Color Liking (9 pt. scale; 1 = Dislike Extremely, 9 = | 7.3 A | 7.1 B | 6.7 C | 6.6 C |
| Like Extremely) | | | | |
| Aroma Liking (9 pt. scale; 1 = Dislike Extremely, | 6.7 A | 6.7 A | 6.2 B | 6.1 B |
| 9 = Like Extremely) | | | | |
| Mixed Berry Flavor Intensity (9 pt. scale; 1 = | 5.7 B | 5.8 B | 6.1 A | 5.3 C |
| Not at all, 9 = Extremely) | | | | |
| Sweetness Intensity (9 pt. scale; 1 = Not at all, | 5.7 B | 5.6 B | 6.1 A | 4.9 C |
| 9 = Extremely) | | | | |
| Sourness Intensity (9 pt. scale; 1 = Not at all, 9 = | 3.3 C | 3.4 C | 4.0 B | 4.9 A |
| Extremely) | | | | |
| Balance of Sweetness to Sourness (9 pt. | 4.5 B | 4.6 B | 4.7 B | 5.4 A |
| scale; 1 = Not at all, 9 = Extremely) | | | | |
| Saltiness Expectations (5 pt. scale; 1 = Much | 3.5 A | 3.6 A | 3.1 B | 3.0 B |
| Worse, 5 = Much Better) | | | | |
| Detect an Aftertaste | | | | |
| % No | 55% A | 55% A | 39% B | 44% B |
| Pleasant | 32% A | 33% A | 24% B | 23% B |
| Unpleasant | 13% B | 12% B | 37% A | 33% A |
| Drinkability (5 pt. scale; 1 = Strongly Disagree, 5 = | 3.6 A | 3.6 A | 2.9 B | 2.9 B |
| Strongly Agree) | | | | |
| Purchase Intent (5 pt. scale; 1 = Definitely | 3.4 B | 3.5 A | 2.8 B | 2.7 B |
| would not buy, 5 = Definitely would buy) | | | | |
| Top 2 Box | 56% A | 55% A | 34% B | 33% B |
| Meets Expectations (5 pt. scale; 1 = Much | 3.5 A | 3.5 A | 2.9 B | 2.8 B |
| Worse, 5 = Much Better) | | | | |

means with different letters indicate a significance difference at 95% two-tailed.

What is claimed is:

1. A composition comprising a high-concentrate beverage syrup comprising a salt blend including at least two salts selected from the group consisting of chlorides, citrates, phosphates, gluconates, carbonates, sulfates, and lactates, the syrup including about 10,000 ppm chloride or less.

2. The composition of claim 1, comprising an electrolyte solution of salts selected from the group consisting of sodium, potassium, magnesium, calcium, and zinc, or combinations thereof.

3. The composition of claim 1, comprising sodium from about 100 mg/L to about 185,000 mg/L.

4. The composition of claim 1, comprising potassium from about 25 mg/L to about 50,000 mg/L.

5. The composition of claim 1, comprising magnesium from about 5 mg/L to about 2,000 mg/L.

6. The composition of claim 1, comprising calcium from about 5 mg/L to about 6000 mg/L.

7. The composition of claim 1, comprising zinc from about 1 mg/L to about 5,000 mg/L.

8. The composition of claim 1, comprising sodium, potassium, magnesium, calcium, and zinc.

9. The composition of claim 1, wherein the syrup exhibits organoleptic, functional or nutritional characteristics similar to an equivalent high-concentrate syrup having about 10,000 ppm chloride or greater.

10. The composition of claim 1, wherein the salt blend comprises salts selected from the group consisting of about 100 mg/L to about 185,000 mg/L sodium, about 25 mg/L to about 50,000 mg/L potassium, about 5 mg/L to about 2,000 mg/L magnesium, about 5 mg/L to about 6,000 mg/L calcium, and about 1 mg/L to about 5,000 mg/L zinc, or combinations thereof.

11. The composition of claim 10, wherein the salt blend comprises sodium, potassium, magnesium, calcium, and zinc, each from about 1 mg/L to about 185,000 mg/L.

12. The composition of claim 1, comprising a non-nutritive sweetener.

13. The composition of claim 12, wherein the non-nutritive sweetener is selected from the group consisting of Stevia rebaudiana extract, stevioside, cyclamate, neotame, erythritol, luo han guo, monk fruit, acesulfame potassium, aspartame, saccharine, and sucralose, or any combination or derivative thereof.

14. The composition of claim 12, wherein the non-nutritive sweetener is rebaudioside A.

15. The composition of claim 1, comprising a nutritive sweetener.

16. The composition of claim 15, wherein the nutritive sweetener is selected from the group consisting of sucrose, fructose, glucose, polydextrose, and trehalose, from natural or purified sources.

17. The composition of claim 1, comprising an additive selected from the group consisting of salts, food-grade acids, caffeine, emulsifiers, stabilizers, antioxidants, coloring agents, preservatives, energy-boosting agents, tea, botanicals, coffee, minerals and vitamins.

18. A method of making a low-chloride, high-concentrate beverage syrup comprising combining a high-concentrate beverage syrup and a salt blend comprising at least two salts selected from the group consisting of chlorides, citrates, phosphates, gluconates, carbonates, sulfates, and lactates, wherein the syrup comprises about 10,000 ppm chloride or less.

19. The method of claim 18, wherein the syrup comprises an electrolyte solution of salts selected from the group consisting of sodium, magnesium, potassium, calcium, and zinc, or combinations thereof.

20. The method of claim 19, wherein the high-concentrate beverage syrup comprises sodium from about 100 mg/L to about 185,000 mg/L.

21. The method of claim 19, wherein the high-concentrate beverage syrup comprises potassium from about 25 mg/L to about 50,000 mg/L.

22. The method of claim 19, wherein the high-concentrate beverage syrup comprises magnesium from about 5 mg/L to about 2,000 mg/L.

23. The method of claim 19, wherein the high-concentrate beverage syrup comprises calcium from about 5 mg/L to about 6000 mg/L.

24. The method of claim 25, comprising zinc from about 1 mg/L to about 5000 mg/L.

25. The method of claim 18, wherein the high-concentrate beverage syrup exhibits organoleptic, functional or nutritional characteristics similar to an equivalent high-concentrate beverage syrup having about 10,000 ppm chloride or greater.

26. The method of claim 18, wherein the salt blend comprises at least sodium, potassium, magnesium and calcium each from about 1 mg/L to about 185,000 mg/L.

27. The method of claim 18, wherein the high-concentrate beverage syrup comprises a non-nutritive sweetener.

28. The method of claim 27, wherein the non-nutritive sweetener is selected from the group consisting of Stevia rebaudiana extract, stevioside, aspartame, acesulfame potassium, monk fruit, saccharine, sucralose and sugar alcohols.

29. The method of claim 18, wherein the high-concentrate beverage syrup comprises a nutritive sweetener.

30. The method of claim 29, wherein the nutritive sweetener is selected from the group consisting of sucrose, fructose, glucose and polydextrose.

31. The method of claim 18, wherein the high-concentrate beverage syrup comprises an additive selected from the group consisting of salts, food-grade acids, caffeine, emulsifiers, stabilizers, antioxidants, coloring agents, preservatives, energy-boosting agents, tea, botanicals, coffee, minerals, and vitamins.

32. A beverage dispenser comprising:
a) a pump including metal components including springs, plungers, and piping; and
b) a storage vessel containing low-chloride, high-concentrate beverage syrup to dispense the syrup via the metal components.

33. A method of reducing corrosion in a beverage dispenser comprising dispensing a low-chloride, high-concentrate beverage syrup from a beverage dispenser, whereby the beverage dispenser containing less corrosion than an equivalent beverage dispenser comprising a high-chloride, high-concentrate beverage syrup.

34. A method of making an electrolyte-enriched beverage comprising mixing a composition of claim 1 with a volume of mixer to form a mixed beverage, whereby the mixed beverage including an electrolyte concentration of about 100 mg/L to about 185,000 mg/L sodium, about 25 mg/L to about 50,000 mg/L potassium, about 5 mg/L to about 2,000 mg/L magnesium, about 5 mg/L to about 6,000 mg/L calcium, and about 1 mg/L to about 5,000 mg/L zinc, or combinations thereof.

35. An enhanced-hydration beverage comprising a salt blend including at least two salts selected from the group consisting of chlorides, citrates, phosphates, gluconates, carbonates, sulfates, and lactates, the beverage including about 1,000 ppm chloride or less.
